(19) United States
(12) Patent Application Publication
(10) Pub. No.: US 2022/0174357 A1
(43) Pub. Date: Jun. 2, 2022

(54) SIMULATING AUDIENCE FEEDBACK IN REMOTE BROADCAST EVENTS

(71) Applicants: AT&T Intellectual Property I, L.P., Atlanta, GA (US); AT&T Mobility II LLC, Atlanta, GA (US)

(72) Inventors: Eric Zavesky, Austin, TX (US); John Oetting, Zionsville, PA (US); Terrel Lecesne, Round Rock, TX (US); James H. Pratt, Round Rock, TX (US); Jason Decuir, Cedar Park, TX (US)

(21) Appl. No.: 17/106,871

(22) Filed: Nov. 30, 2020

(51) Int. Cl. H04N 21/442; G06K 9/00

(52) U.S. Cl. CPC H04N 21/44213; G06K 9/00302

(57) ABSTRACT

An example method includes presenting a remote broadcast event to a first set of user endpoint devices including at least one host device and a second set of user endpoint devices including a plurality of audience devices, monitoring reactions of audience members of the remote broadcast event, based on streams of data received from the second set of user endpoint devices, and displaying, to the first set of user endpoint devices, a measure of the reactions of the audience members, based on the monitoring.

The present disclosure relates generally to media distribution, and relates more particularly to devices, non-transitory computer-readable media, and methods for simulating audience feedback in remote broadcast events.

### BACKGROUND

Remote broadcast technology, such as video conferencing, has emerged as a viable means of implementing events (particularly large-scale events) in a socially distanced manner. For instance, events such as concerts, theatrical performances, meetings, classes, tours, and professional conferences can be rendered as experiences in which each participant joins remotely rather than in-person, with minimal detriment to the audience experience.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for simulating audience feedback in remote broadcast events may operate;

FIG. 2 illustrates a flowchart of an example method for simulating audience feedback in remote broadcast events, in accordance with the present disclosure;

FIG. 3, for instance, illustrates an example dashboard-style graphical user interface (or simply “dashboard”) that may be presented to a host of a remote broadcast event, according to examples of the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for simulating audience feedback in remote broadcast events. In one example, a method performed by a processing system includes presenting a remote broadcast event to a first set of user endpoint devices including at least one host device and a second set of user endpoint devices including a plurality of audience devices, monitoring reactions of audience members of the remote broadcast event, based on streams of data received from the second set of user endpoint devices, and displaying, to the first set of user endpoint devices, a measure of the reactions of the audience members, based on the monitoring.

In another example, a non-transitory computer-readable medium may store instructions which, when executed by a processing system in a communications network, cause the processing system to perform operations. The operations may include presenting a remote broadcast event to a first set of user endpoint devices including at least one host device and a second set of user endpoint devices including a plurality of audience devices, monitoring reactions of audience members of the remote broadcast event, based on streams of data received from the second set of user endpoint devices, and displaying, to the first set of user endpoint devices, a measure of the reactions of the audience members, based on the monitoring.

In another example, a device may include a processing system including at least one processor and non-transitory computer-readable medium storing instructions which, when executed by the processing system when deployed in a communications network, cause the processing system to perform operations. The operations may include presenting a remote broadcast event to a first set of user endpoint devices including at least one host device and a second set of user endpoint devices including a plurality of audience devices, monitoring reactions of audience members of the remote broadcast event, based on streams of data received from the second set of user endpoint devices, and displaying, to the first set of user endpoint devices, a measure of the reactions of the audience members, based on the monitoring.

As discussed above, remote broadcast technology, such as video conferencing, has emerged as a viable means of implementing events (particularly large-scale events) in a socially distanced manner. For instance, events such as concerts, theatrical performances, meetings, classes, tours, and professional conferences can be rendered as experiences in which each participant joins remotely rather than in-person, with minimal detriment to the audience experience. From the perspective of the event host (e.g., presenter or performer), however, there may be drawbacks to the remote experience. For instance, it is harder for the host to gauge audience feedback or engagement. Typical solutions implemented in video conferencing applications tend to alternate between views of random audience members on the host's display, but this may not give a true measure of the aggregate audience response. The inability to properly gauge audience engagement may also be a drawback for the audience themselves. For instance, if audience engagement is low, this is not likely to be improved by continuing to look at a static display of the host.

Examples of the present disclosure monitor the reactions of audience members during a live, remote broadcast and process these reactions in order to provide the host (e.g., presenter or performer) of the remote broadcast event with real time audience feedback, just as the host would receive if he or she were presenting in front of an in-person audience. This may help the host to feel more connected (and, potentially, more comfortable) with the audience, to better gauge the audience's reaction to the material being presented, and/or to adapt the presentation to the audience's reactions to improve engagement.

Furthermore, examples of the present disclosure may also increase audience comfort and engagement by providing selected audience feedback to other members of the audience. For instance, if an audience member is laughing, audio of other audience members laughing could be presented to make the audience member feel a greater sense of camaraderie with the others. Where available, the processing system may also communicate with IoT devices that are co-located with an audience member in order to improve the audience member's level of engagement.

Although examples of the present disclosure are discussed within the context of visual media, it will be appreciated that the examples described herein could apply equally to non-visual media, or to media that does not have a visual component. For instance, examples of the present disclosure could be used to dynamically adapt a podcast, a streaming radio station, an audio book, or the like.

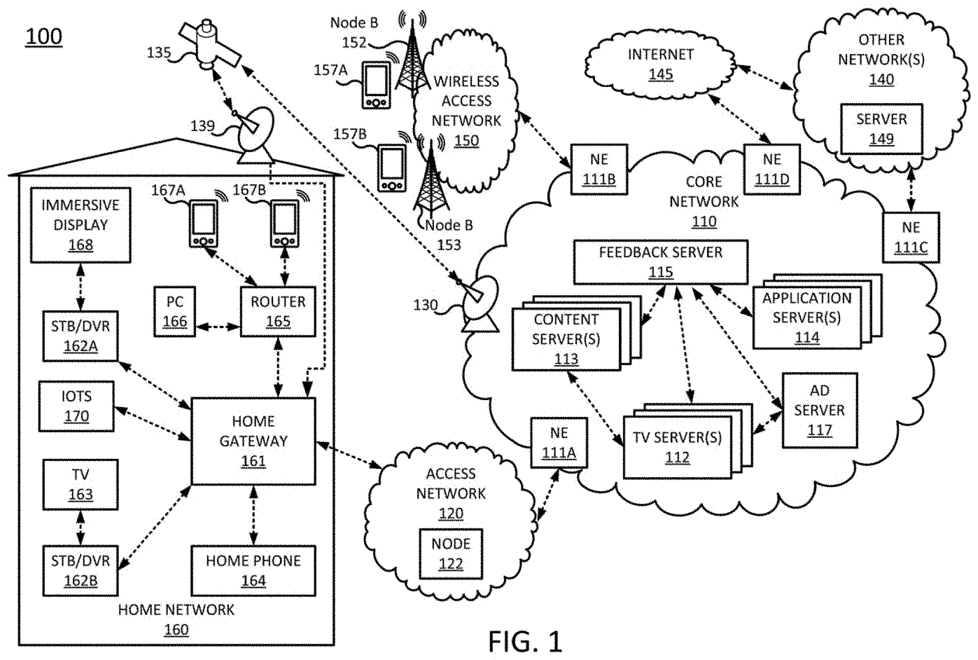

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth, with one another and with various other devices via a core network 110, a wireless access network 150 (e.g., a cellular network), an access network 120, other networks 140 and/or the Internet 145. In some examples, not all of the mobile devices and home network devices will be utilized in presenting a remote broadcast event. For instance, in some examples, presentation of a remote broadcast event may make use of the home network devices (e.g., immersive display 168, STB/DVR 162A, and/or Internet of Things devices (IoTs) 170), and may potentially also make use of any co-located mobile devices (e.g., mobile devices 167A and 167B), but may not make use of any mobile devices that are not co-located with the home network devices (e.g., mobile devices 157A and 157B).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an feedback server 115 (e.g., an application server). For ease of illustration, various additional elements of core network 110 are omitted from FIG. 1.

In one example, feedback server 115 may monitor audience members' reactions to a remote broadcast event, which may be delivered to a plurality of user endpoint devices, including a device in the home network 160 (e.g., one or more of the mobile devices 157A, 157B, 167A, and 167B, the PC 166, the home phone 164, the TV 163, the immersive display 168, and/or the Internet of Things devices (IoTs) 170) by the TV servers 112, the content servers 113, the application servers 114, the ad server 117, and/or and immersion server. For instance, the feedback server 115 may receive data related to the audience members' reactions directly from the device(s) to which the remote broadcast event is delivered (e.g., the devices presenting the remote broadcast events to the audience members). The data may include, e.g., sensor readings from one or more sensors of the device to which the remote broadcast event is delivered (e.g. cameras, microphones, biometric sensors, etc.). The data may be received by the feedback server 115 in real time, e.g., as the sensors collect the data. The feedback server 115 may alternatively or in addition receive the data from other devices in the vicinity of the device(s) to which the remote broadcast event is being delivered. For instance, the data could be collected by one or more IoT devices (e.g., a virtual assistant device, a security system, an image capturing system, etc.), by the user's mobile phone or wearable smart device (e.g., smart watch or fitness tracker), or the like.

The feedback server 115 may analyze the data in real time (e.g., as the data is received) in order to estimate the audience's current reaction to and engagement with the remote broadcast event. The feedback server 115 may estimate the audience's reactions in a variety of ways. For instance, the feedback server 115 could perform image processing on camera images of the audience members (e.g., facial analysis of images of the audience members' face, or image analysis of the audience members' body language, could yield clues as to the audience's reactions or levels of engagement). Alternatively, the feedback server 115 could perform content analysis on audio signals of the audience members (e.g., the audience's reactions could be indicated by laughing, yawning, cheering, etc.; sentiment analysis may be performed on utterances made by the audience members, such as statements of boredom, interest, or the like). In further examples, the feedback server 115 may perform an analysis of biometric indicators of the audience members in order to estimate the audience's reactions (e.g., readings from an audience member's fitness tracker may indicate that the audience member has fallen asleep, indicating a lack of interest or engagement).

In response to the estimating the audience's reactions or engagement, the feedback server 115 may select and transmit evidence of the audience reactions to a user endpoint device operated by the host of the remote broadcast event. For instance, the feedback server 115 may transmit live/video images of the audience members who are estimated to be the most engaged and/or least engages in the remote broadcast event, so that the host has a view to the audience reactions just as he would have during an in-person event. In another example, the feedback server 115 could aggregate the estimated reactions of multiple audience members in order to provide an estimate of an aggregate audience reaction (e.g., is most of the audience engaged, bored, etc.). Aggregated and/or individual reactions could be displayed to the host as graphics (e.g., bar charts or the like) to show the engagement of the audience (in general, or specific members) at specific times, over time, and the like.

In a further example, the feedback server 115 may use gaze tracking techniques to detect audience members who are looking directly at the displays of their user endpoint devices. The feedback server 115 may choose to provide live video feeds of one or more audience members who are looking directly at their displays to the host, thereby giving the host the opportunity to virtually “make eye contact” with audience members and increase the host's sense of engagement with the audience.

In further examples, the feedback server 115 may also provide data to the user endpoint devices of the audience members in order to increase the audience's engagement and/or sense of group. For instance, if the feedback server 115 detects that a specific audience member is laughing at a joke, the feedback server 115 may play back to that specific audience member audio of other audience members laughing, in order to simulate a more communal experience. If the feedback server 115 detects that a specific audience member is dozing off, the feedback server 115 may provide commands to the specific audience member's user endpoint device (or to a device that is co-located with the specific audience member's user endpoint device) in order to wake the specific audience member up. For instance, the feedback server could instruct the user endpoint device to play the sound of an alarm clock ringing, or could instruct an Internet-connected thermostat that is co-located with the user endpoint device to lower the ambient temperature.

The feedback server 115 may also have access to third party data sources (e.g., server 149 in other network 140), where the third party data sources may comprise historical, background and other data relating to the types of audience reactions that are expected or typical for different sorts of remote broadcast events. For instance, an audience member who appears to be dozing off might be expected during a virtual yoga class, but not during a virtual college lecture.

The feedback server 115 may interact with television servers 112, content servers 113, and/or advertising server 117, to select which video programs (or other content), advertisements, and/or feedback to include in a remote broadcast event being delivered to a user endpoint device. For instance, the content servers 113 may store scheduled television broadcast content for a number of television channels, video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to subscribers, e.g., in the home network 160 and at other downstream viewing locations. For example, advertisers may upload various advertising content to the core network 110 to be distributed to various viewers.

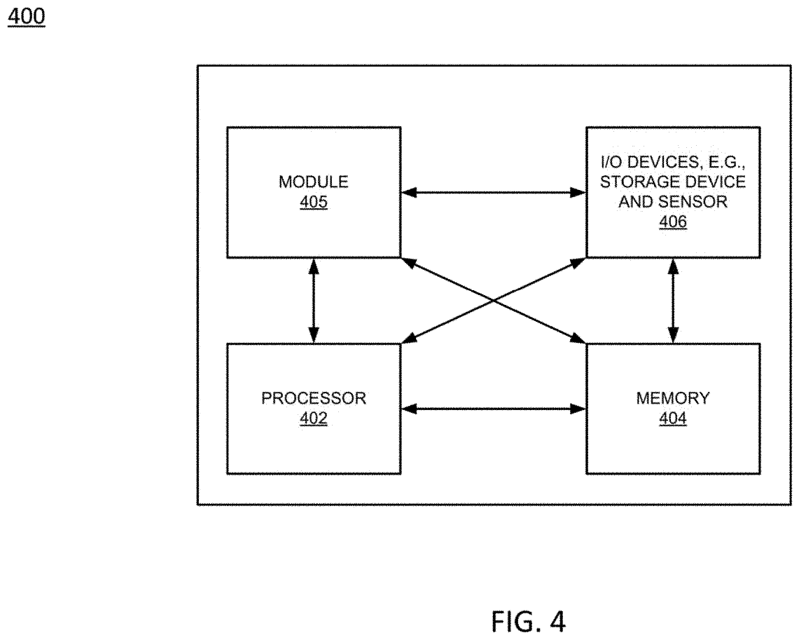

In one example, any or all of the television servers 112, content servers 113, application servers 114, feedback server 115, and advertising server 117 may comprise a computing system, such as computing system 400 depicted in FIG. 4.

In one example, the access network 120 may comprise a Digital Subscriber Line (DSL) network, a broadband cable access network, a Local Area Network (LAN), a cellular or wireless access network, a 3rd party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163 and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, IoTs 170 and so forth.

In one example, router 165 may further communicate with TV (broadly a display) 163 and/or immersive display 168, e.g., where one or both of the television and the immersive display incorporates “smart” features. The immersive display may comprise a display with a wide field of view (e.g., in one example, at least ninety to one hundred degrees). For instance, head mounted displays, simulators, visualization systems, cave automatic virtual environment (CAVE) systems, stereoscopic three dimensional displays, and the like are all examples of immersive displays that may be used in conjunction with examples of the present disclosure. In other examples, an “immersive display” may also be realized as an augmentation of existing vision augmenting devices, such as glasses, monocles, contact lenses, or devices that deliver visual content directly to a user's retina (e.g., via mini-lasers or optically diffracted light). In further examples, an “immersive display” may include visual patterns projected on surfaces such as windows, doors, floors, or ceilings made of transparent materials.

In another example, the router 165 may further communicate with one or more IoTs 170, e.g., a connected security system, an automated assistant device or interface, a connected thermostat, a connected speaker system, or the like. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163 and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

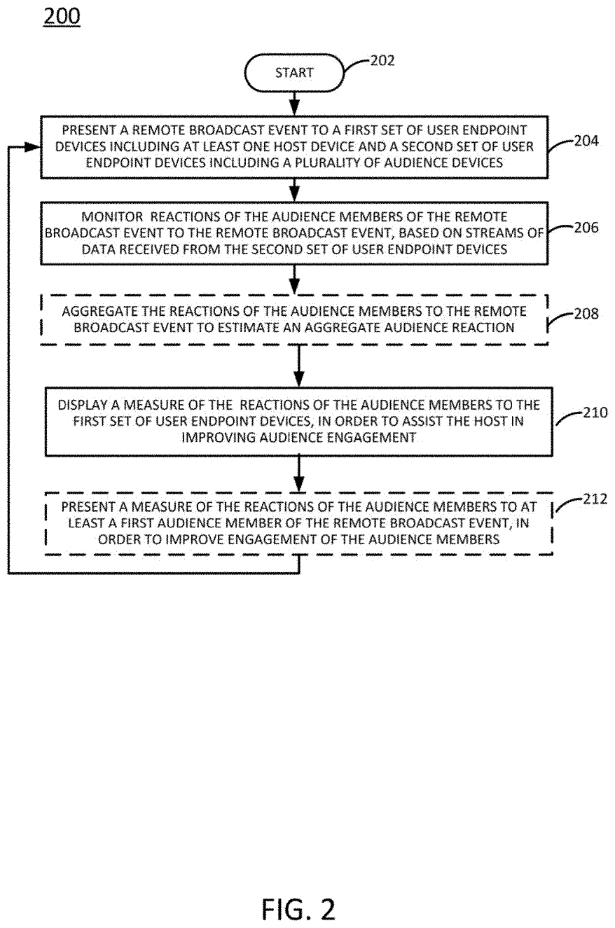

FIG. 2 illustrates a flowchart of an example method 200 for simulating audience feedback in remote broadcast events, in accordance with the present disclosure. In one example, steps, functions and/or operations of the method 200 may be performed by a device as illustrated in FIG. 1, e.g., feedback server 115 or any one or more components thereof. In one example, the steps, functions, or operations of method 200 may be performed by a computing device or system 400, and/or a processing system 402 as described in connection with FIG. 4 below. For instance, the computing device 400 may represent at least a portion of the feedback server 115 in accordance with the present disclosure. For illustrative purposes, the method 200 is described in greater detail below in connection with an example performed by a processing system, such as processing system 402.

The method 200 begins in step 202. In step 204, the processing system may present a remote broadcast event to a first set of user endpoint devices including at least one host device (e.g., a user endpoint device operated by a host, such as a presenter or performer, of the remote broadcast) and a second set of user endpoint devices including a plurality of audience devices (e.g., user endpoint devices operated by members of the audience of the remote broadcast), wherein the first set of user endpoint devices and the second set of user endpoints devices are geographically distributed (i.e., in different geographic locations). Thus, the remote broadcast may include a plurality of participants including at least one host and a plurality of audience members. The plurality of user endpoint devices may include any types of devices that are capable of presenting a remote broadcast event (e.g., a video conferring or similar event), either alone or in combination with other devices. For instance, a user endpoint device of the plurality of user endpoint devices may comprise an immersive display, such as a head mounted display, a stereoscopic three-dimensional display, or the like. The user endpoint device of the plurality of user endpoint devices may also comprise a more conventional display, such as a television, a tablet computer, or the like, that is co-located (e.g., in the same room as) one or more IoT devices, such as a smart thermostat, a smart lighting system, a smart audio system, a virtual assistant device, or the like.

The remote broadcast event may be presented in accordance with any known techniques for presenting multi-participant video conferencing. For instance, the processing system may collect audio and video data from the first set of user endpoint devices and the second set of user endpoint devices. Each user endpoint device of the first set of user endpoint devices and the second set of user endpoint devices may include at least a camera to collect video data of the associated participant and a microphone to collect audio data of the associated participant. Each user endpoint device of the first set of user endpoint devices and the second set of user endpoint devices may therefore send a stream of data to the processing system that includes video and/or audio data of the associated participant (which may be compressed for delivery to the processing system and decompressed upon receipt by the processing system). The processing system may mix the video and/or audio data from the different user endpoint device streams and deliver, to each user endpoint device of the first set of user endpoint devices and the second set of user endpoint devices, a (possibly compressed) mixed stream that displays, in some way, the participants associated with the other user endpoint devices (e.g., the display may show small images of all of the other participants, may switch between images of the participants who are currently speaking, or may show a large image of the participant who is currently speaking and smaller images of at least some of the other participants, etc.).

In one example, the remote broadcast event may comprise an event having a plurality of participants, such as a class, a conference, a concert or theatrical performance, a tour, or a meeting. The participants of remote broadcast event, as described above, may include one or a limited number of hosts (e.g., presenters of performers) and a plurality of audience members (e.g., tens, hundreds, or even thousands of individuals watching the presenter(s) or performer(s)). Thus, when presented with the remote broadcast event, a device in the second set of user endpoint devices (i.e., a device operated by an audience member) may display an image of the host and play audio of the host, and optionally may also display images of one or more of the other audience members. A device in the first set of user endpoint devices (i.e., a device operated by the host) may display images of several audience members, but may or may not play audio of the audience members.

In step 206, the processing system may monitor the reactions of the audience members to the remote broadcast event, based on the streams of data received from the second set of user endpoint devices. In one example, audience members may opt-in (e.g., providing their consent) for the monitoring of their reactions in order to avoid intruding on the privacy of the participants. In a further example, the opt-in may include an enrollment or training process (e.g., performed prior to presentation of the remote broadcast event) in which the processing system may present various types of material to an opted-in audience member in order to determine the signs of different reactions that are specific to the audience member (e.g., laughter in combination with some other indicators, such as fidgeting, may indicate that the user is nervous rather than amused).

In one example, the monitoring may comprise performing image processing on the video components of the streams of data in order to estimate the individual reactions of the audience members. Machine learning techniques could be used to infer meaning from data that is extracted as a result of the processing. For instance, the processing system may be trained to recognize indicators for certain types of sentiments or reactions. In addition, by continuously monitoring audience member reactions during remote broadcast events, the processing system may learn to recognize new indicators.

For instance, in one example, the image processing techniques may comprise techniques that detect and/or track one or more facial features or gestures of an audience member. As an example, a gaze tracking technique could be used to detect an audience member's eyes and then to track the audience member's eye movements to detect a direction of the audience member's gaze. By tracking the audience member's gaze, the processing system may be able to determine whether the audience member is paying attention to the remote broadcast event (e.g., whether the audience member is engaged). For instance, if the audience member is looking at the display of his user endpoint device, then the processing system may infer that the audience member is paying attention to the remote broadcast event. However, if the audience member is looking away from the display of his user endpoint device (e.g., is looking at his phone instead) for more than a threshold period of time (e.g., more than x seconds), then the processing system may infer that the audience member is not paying attention to the remote broadcast event (e.g., is not engaged or is distracted or bored).

In another example, a facial feature detection technique could be used to detect the audience member's mouth and then to infer a sentiment of the audience member from movements of the audience member's mouth. For instance, if the audience member is smiling or laughing, then the processing system may infer that the audience member is reacting positively to the remote broadcast event. If the audience member is frowning, then the processing system may infer that the audience member is reacting negatively to the remote broadcast event. If the audience member's mouth is moving, this may indicate that the audience member is talking, and the processing system may infer that the audience member is not paying attention to the remote broadcast event. Other facial expressions could be mapped to other sentiments (e.g., furrowed eyebrows could indicate confusion, wide eyes could indicate surprise, etc.).

In another example, an object detection and recognition technique could be used to detect any objects, people, or the like in the audience member's vicinity which may be possible sources of distraction. For instance, if the audience member is holding a phone up to his ear, then the processing system may infer that the audience member is talking on his phone or listening to voice messages, and is therefore distracted (or not engaged/paying attention). Similarly, if the audience member appears to be talking to a child, then the processing system may infer that the audience member is distracted.

In another example, the monitoring may comprise performing audio processing on the audio components of the streams of data in order to estimate the individual reactions of the audience members. For instance, sound recognition techniques could be used to detect when an audience member is laughing, from which the processing system may infer that the audience member is amused by or is responding positively to the remote broadcast event. In another example, sound recognition techniques could be used to detect when the audience member is talking, from which the processing system may infer that the audience member is not paying attention to the remote broadcast event. In another example, speech recognition and/or sentiment analysis may be used to detect words spoken by the audience member and sentiments expressed by those words, from which the processing system may be able to more explicitly infer a reaction of the audience member (e.g., “How much longer is this?” versus “This guy is hilarious.”).

In another example, the monitoring may comprise measuring the quality of the service received by the audience member's user endpoint device. For instance, the processing system may observe timestamps of packets sent between the processing system and the audience member's user endpoint device in order to determine the latency of the network connection between the processing system and the audience member's user endpoint device. In some examples, poor quality of service metrics (such as poor latency, poor signal strength, poor throughput, excessive packet loss, and the like) may be related to an audience member's lack of engagement with the remote broadcast event. For instance, if the video and/or audio of the remote broadcast event is constantly freezing or buffering on the audience member's user endpoint device, the audience member may lose interest.

In one example, estimation of audience reactions based on the monitoring may be calibrated to the type of the remote broadcast event being presented. Different types and levels of feedback may be expected or desirable based on the nature of the remote broadcast event. For instance, during a presentation of a virtual professional conference, a quiet, composed audience might be interpreted as a sign that the audience is paying attention; however, during a virtual stand-up comedy show, a quiet, composed audience could be a sign that the jokes are falling flat. Machine learning techniques can be used to learn, for each type of remote broadcast event, what types of audience reactions are desirable or expected and what types of audience reactions are undesirable or unexpected.

In optional step 208 (illustrated in phantom), the processing system may aggregate the reactions of the audience members to the remote broadcast event to estimate an aggregate audience reaction. For instance, the processing system may consider the individual reactions of the audience members, which may be estimated as discussed above, and may aggregate those individual reactions in some way to estimate a general mood of the audience as a whole. For instance, the processing system could determine an average audience reaction (e.g., the average audience member appears to be engaged), a difference in the average audience reaction from a previous time point (e.g., the average audience member seems less engaged now than earlier in the remote broadcast event), extremes in audience reactions (e.g., some audience members are laughing, but a few other audience members appear to be angry). In one example, audience reactions as determined in step 206 may be scored on some scale (e.g., one through ten, where one indicates a lowest level of engagement and ten indicates a highest level of engagement), and the scores may be averaged to determine the corresponding average level of engagement of the audience as a whole.

In step 210, the processing system may display, to the first set of user endpoint devices, a measure of the reactions of the audience members to the remote broadcast event, based on the monitoring (e.g., in order to assist the host in improving audience engagement). For instance, in one example, the processing system may deliver data to the first set of user endpoint devices that cause the first set of user endpoint devices to display a “dashboard”-style user interface as part of the remote broadcast event. The dashboard-style user interface may show, for example, images of the audience members who are estimated to be the most engaged and least engaged, graphics (e.g., bar charts or similar graphics) to show the engagement of the audience (e.g., average audience of select individual audience members) over time.

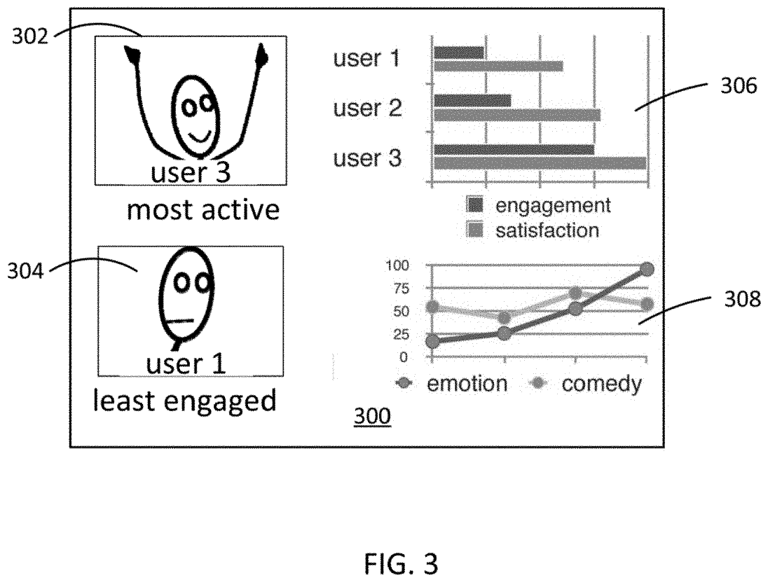

FIG. 3, for instance, illustrates an example dashboard-style graphical user interface (or simply “dashboard”) 300 that may be presented to a host of a remote broadcast event, according to examples of the present disclosure. As illustrated, the dashboard 300 may include a plurality of live video regions 302 and 304 in which the processing system may provide live video feeds of different audience members of the remote broadcast event. In one example, the dashboard may include at least two live video regions 302 and 304. For instance, a first live video region 302 may provide a live video feed of the audience member who the processing system has estimated to be the most engaged in the remote broadcast event, while a second live video region 304 may provide a live video feed of the audience member who the processing system has estimated to be the least engaged in the remote broadcast event. In further examples, however, the dashboard may include additional live video regions in order to display a wider range of audience reactions. The audience members whose live video feeds are displayed in the live video regions 302 and 304 may change over time as different audience members may be estimated to be the most and/or least engaged; thus, the live video regions 302 and 304 may represent, at any time, the extremes of the audience reactions to the remote broadcast event. The live video regions 302 and 304 may or may not enable the host to also receive audio of the audience members whose live video feeds are displayed.

In another example, the live video regions 302 and 304 of the dashboard could be used to display to the host one or more audience members with whom the host can, at least virtually, make eye contact. For instance, as discussed above, the processing system may implement gaze tracking techniques in order to track the gazes of the audience members. The processing system could identify one or more audience members whose gazes are consistently locked on their displays, and could display live video feeds of the one or more audience members to the host to simulate the experience of making eye contact with the audience. This may help the host to feel more connected to the remote audience.

In one example, the dashboard may additionally comprise one or more analytic regions, such as analytic regions 306 and 308, that display graphics derived from the estimates of the audience reactions. For instance, a first analytic region 306 may display a bar chart indicating, for various audience members (e.g., in one example, at least the least engaged and most engaged audience members) their current estimated levels of engagement and/or satisfaction with the remote broadcast event. A second analytic region 308 might display a line graph showing, for the various audience members, an estimated level of a specific emotion (e.g., amusement, annoyance, etc.) over time. Additional analytic regions may be included to display different graphics derived from the estimates of the audience reactions.

Referring back to FIG. 2, in optional step 212 (illustrated in phantom), the processing system may present or display a measure of the audience reactions of the audience members to at least a first audience member, in order to improve audience engagement. In one example, displaying the measure of the audience reaction may involve estimating a reaction of the first audience member, and then displaying to the first audience member reactions of other audience members who reacted in a similar manner. For instance, if the processing system determines that the first audience member is laughing during a virtual stand-up comedy show, then the processing system may display live video feeds of one or more other audience members who are also laughing. Alternatively, the processing system may just play audio of the one or more other audience members laughing, without altering the first audience member's view or display (e.g., so that the first audience member may still just be watching the host). If the processing system determines that the first audience member is singing along during a virtual concert, then the processing system may play audio of other audience members singing along. Seeing or hearing other audience members who are reacting in a similar manner may help the first audience member to feel more connected to and more a part of the remote audience.

The method 200 may then return to step 204, and the processing system may proceed as described above to continuously present the remote broadcast event and to monitor the audience members' reactions while presenting the remote broadcast event. Thus, steps 204-212 may be repeated any number of times until presentation of the remote broadcast event concludes (e.g., the remote broadcast event may come to a scheduled end, or the host or audience member may terminate the remote broadcast event before a scheduled end).

The method 200 therefore allows the host (e.g., presenter or performer) of a live, remote broadcast event to receive real time audience feedback, just as the host would receive if he or she were presenting in front of an in-person audience. This may help the host to feel more connected (and, potentially, more comfortable) with the audience, to better gauge the audience's reaction to the material being presented, and/or to adapt the presentation to the audience's reactions.

For instance, if the remote broadcast event comprises a virtual stand-up comedy show, examples of the present disclosure could help the comedian to determine when his jokes are making the audience laugh, when his jokes are falling flat, and the like. If it appears that a particular line of jokes is failing to engage the audience, the comedian may move on to a different line of jokes in an effort to improve the engagement.

If the remote broadcast event comprises a virtual class (e.g., a college class), examples of the present disclosure could help the professor to determine when members of the class seem confused or disengaged. If it appears that members of the class are confused, the professor could try presenting the material in a different manner to increase the comprehension of the material by the class.

Furthermore, examples of the present disclosure may also increase audience comfort and engagement by providing selected audience feedback to other members of the audience. For instance, if an audience member is laughing, audio of other audience members laughing could be presented to make the audience member feel a greater sense of camaraderie with the others. Similarly, if an audience member appears to be confused, images of other audience members (or perhaps just some graphic that aggregates audience reactions) could be presented to the audience member to make him feel less alone and perhaps encourage him to speak up and ask for clarification. Where available, the processing system may also communicate with IoT devices that are co-located with an audience member in order to improve the audience member's level of engagement (e.g., instructing an Internet-connected thermostat to lower the temperature to wake up an audience member who appears to be dozing off during a virtual college class; instructing an Internet-connected speaker system to include more of an echo in the audio to simulate the sound of being in a large conference room for a virtual professional conference).

As also discussed above, the method 200 may monitor for the quality of service that is being experienced by the plurality of user endpoint devices. This may help the learning portion of the method 200 to better recognize the correlations between certain types of content and certain reactions, particularly for specific audience members. For instance, if an audience member's user endpoint device is experiencing a delay in presenting the remote broadcast event, and the audience member laughs, the processing system may be able to determine that the laughter is a reaction not to something that is currently happening in the remote broadcast event, but to something that happened a few seconds ago.

In further examples, the method 200 could be used to aid advertisers in determining where to place advertising material during a remote broadcast event. For instance, the optimal time to place advertising material may be when a threshold percentage of the audience appears to be paying attention. Thus, the method 200 could be used to determine the best times to present real-time advertising during a remote broadcast event.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for simulating audience feedback in remote broadcast events, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner fora particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for simulating audience feedback in remote broadcast events (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for simulating audience feedback in remote broadcast events (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
presenting, by a processing system including at least one processor, a remote broadcast event to a first set of user endpoint devices including at least one host device and a second set of user endpoint devices including a plurality of audience devices;
monitoring, by the processing system, reactions of audience members of the remote broadcast event, based on streams of data received from the second set of user endpoint devices, wherein the monitoring includes measuring a latency of a network connection between the processing system and each user endpoint device of the second set of user endpoint devices and determining when the latency influences a reaction of the reactions of the audience members;
displaying, by the processing system to the first set of user endpoint devices, a measure of the reactions of the audience members, based on the monitoring; and
sending, by the processing system to an internet of things device that is co-located with a user endpoint device of the second set of user endpoint devices, a signal instructing the internet of things device to take an action to change an environment surrounding a user of the user endpoint device for improving an engagement of the user of the user endpoint device with the remote broadcast event.

2. The method of claim 1, wherein each user endpoint device of the first set of user endpoint devices and the second set of user endpoint devices includes a camera, and the streams of data include video data of the audience members.

3. The method of claim 2, wherein the monitoring comprises:
performing, by the processing system, an image analysis of the video data in order to detect a facial expression of at least one member of the audience members; and
estimating, by the processing system, an engagement of the at least one member based on the facial expression.

4. The method of claim 2, wherein the monitoring comprises:
performing, by the processing system, an object recognition analysis of the video data in order to detect an object in a vicinity of at least one member of the audience members; and
estimating, by the processing system, an engagement of the at least one member based on a presence of the object.

5. The method of claim 1, wherein each user endpoint device of the first set of user endpoint devices and the second set of user endpoint devices includes a microphone, and the streams of data include audio data of an associated member.

6. The method of claim 5, wherein the monitoring comprises:
performing, by the processing system, an audio analysis of the audio data in order to detect a sound made by at least one member of the audience members; and
estimating, by the processing system, an engagement of the at least one member based on the sound.

7. The method of claim 5, wherein the monitoring comprises:
performing, by the processing system, a speech recognition analysis of the audio data in order to detect a word spoken by at least one member of the audience members; and
estimating, by the processing system, an engagement of the at least one member based on the word.

8. The method of claim 1, wherein the displaying the measure comprises:
presenting, by the processing system, video data of at least one audience member of the audience members on the first set of user endpoint devices.

9. The method of claim 8, wherein the at least one audience member comprises a member of the audience members whose engagement is estimated to be highest.

10. The method of claim 8, wherein the at least one audience member comprises a member of the audience members whose engagement is estimated to be lowest.

11. The method of claim 8, wherein the at least one audience member comprises a member of the audience members who is detected to be looking directly at a display of a user endpoint device of the first set of user endpoint devices.

12. The method of claim 1, wherein the displaying comprises:
aggregating, by the processing system, the reactions of the audience members to estimate an aggregate audience reaction to the remote broadcast event; and
presenting, by the processing system, a visual indication of the aggregate audience reaction on the first set of user endpoint devices.

13. The method of claim 12 wherein the visual indication comprises a bar chart illustrating respective levels of engagement of different audience members of the audience members.

14. The method of claim 12, wherein the visual indication comprises a line chart illustrating a level of engagement over time of the audience members.

15. The method of claim 1, further comprising:
presenting, by the processing system on at least one user endpoint device of the second set of user endpoint devices, the measure of the reactions of the audience members, based on the monitoring.

16. The method of claim 15, wherein the presenting the measure of the reactions of the audience members on the at least one user endpoint device of the second set of user endpoint devices comprises playing audio of at least one audience member of the audience members using at least another user endpoint device of the second set of user endpoint devices.

17. (canceled)

18. The method of claim 1, further comprising:
providing, by the processing system, a feedback to at least one audience member of the audience members, based on the monitoring.

19. A non-transitory computer-readable medium storing instructions which, when executed by a processing system including at least one processor, cause the processing system to perform operations, the operations comprising:
presenting a remote broadcast event to a first set of user endpoint devices including at least one host device and a second set of user endpoint devices including a plurality of audience devices;
monitoring reactions of audience members of the remote broadcast event, based on streams of data received from the second set of user endpoint devices, wherein the monitoring includes measuring a latency of a network connection between the processing system and each user endpoint device of the second set of user endpoint devices and determining when the latency influences a reaction of the reactions of the audience members;
displaying, to the first set of user endpoint devices, a measure of the reactions of the audience members, based on the monitoring; and
sending, to an internet of things device that is co-located with a user endpoint device of the second set of user endpoint devices, a signal instructing the internet of things device to take an action to change an environment surrounding a user of the user endpoint device for improving an engagement of the user of the user endpoint device with the remote broadcast event.

20. A device comprising:
a processing system including at least one processor; and
a non-transitory computer-readable medium storing instructions which, when executed by the processing system, cause the processing system to perform operations, the operations comprising:
presenting a remote broadcast event to a first set of user endpoint devices including at least one host device and a second set of user endpoint devices including a plurality of audience devices;
monitoring reactions of audience members of the remote broadcast event, based on streams of data received from the second set of user endpoint devices, wherein the monitoring includes measuring a latency of a network connection between the processing system and each user endpoint device of the second set of user endpoint devices and determining when the latency influences a reaction of the reactions of the audience members;
displaying, to the first set of user endpoint devices, a measure of the reactions of the audience members, based on the monitoring; and
sending, to an internet of things device that is co-located with a user endpoint device of the second set of user endpoint devices, a signal instructing the internet of things device to take an action to change an environment surrounding a user of the user endpoint device for improving an engagement of the user of the user endpoint device with the remote broadcast event.

21. (canceled)

22. The method of claim 1, wherein the internet of things device comprises an internet-connected thermostat, and the signal instructs the internet-connected thermostat to lower a temperature to attempt to wake the user of the user endpoint device when the user of the user endpoint device appears to be sleeping during the remote broadcast event.
